(19) United States
(12) Patent Application Publication
(10) Pub. No.: US 2025/0289006 A1
(43) Pub. Date: Sep. 18, 2025

(54) ION BOX COMPATIBLE WITH DIRECT-CURRENT POWER SUPPLY AND VORTEX POWER SUPPLY, AND PURIFICATION DEVICE

(71) Applicant: AirQuality Technology (Shanghai) Co., Ltd., Shanghai (CN)

(72) Inventors: Shanqing MENG, Shanghai (CN); Kui CAI, Shanghai (CN); Shidan LONG, Shanghai (CN)

(21) Appl. No.: 19/016,667

(22) Filed: Jan. 10, 2025

Related U.S. Application Data
(63) Continuation of application No. PCT/CN2024/101229, filed on Jun. 25, 2024.

(30) Foreign Application Priority Data
Mar. 12, 2024 (CN) 2024102781339

(51) Int. Cl. B03C 3/66; B03C 3/41; B03C 3/53

(52) U.S. Cl. CPC B03C 3/66; B03C 3/41; B03C 3/53

(57) ABSTRACT

The present invention relates to an ion box compatible with direct-current power supply and vortex power supply, and a purification device, belonging to the technical field of air purification. The ion box includes a frame, where a dust collection area and an ionization area are arranged inside the frame in parallel, both the dust collection area and the ionization area include a plurality of polar plates parallel to each other and arranged at intervals, a distance between adjacent low-voltage polar plates or adjacent high-voltage polar plates located in the ionization area is 44-58 mm, a distance between adjacent low-voltage polar plates located in the dust collection area is 11-16 mm, an ionization electric field is formed inside the ionization area. According to the present invention, the technical problem in the prior art that the purification efficiency is affected by frequent cleaning and maintenance of the purification device can be solved.

### CROSS-REFERENCE TO RELATED APPLICATIONS

The present application claims priority to Chinese Patent Application No. 2024102781339, filed on Mar. 12, 2024, the entire disclosure of which is incorporated herein by reference.

### TECHNICAL FIELD

The present invention belongs to the technical field of air purification, and in particular to an ion box compatible with direct-current power supply and vortex power supply, and a purification device.

### BACKGROUND

Currently, mainstream technologies for air purification are divided into a filtration technology and an electrostatic technology. The electrostatic technology charges particulate matters in the air through an ionization area, and the charged particulate matters are adsorbed by an electric field formed by a dust collection area to complete purification. Various high-voltage electrostatic dust removal devices designed by using the principle of the electrostatic technology can purify a wide range of flow rates and complete particle pollution, can be used relatively stably in environments such as different temperatures and humidities, can be well applied to the fields of household, commerce, industry, special purpose and the like, and have the technical characteristics of long service life, high purification efficiency, low operating cost and low maintenance cost. The high-voltage electrostatic dust removal devices are required to be cleaned and maintained with the continuous accumulation of pollutants such as adsorbed particulate matters. Some of the high-voltage electrostatic dust removal devices are required to be shut down during cleaning and maintenance. Ion boxes inside are removed, are cleaned and maintained manually in an open space, are dried or blow-dried, and then are put into equipment. Some of the high-voltage electrostatic dust removal devices are not required to remove ion boxes and can be cleaned by an automatic cleaning device, but the cleaning effect is not excellent and the efficiency after cleaning cannot be completely recovered. After cleaning, the equipment is wet and has water, so the equipment is required to be placed for a long time for drying before operating; otherwise, the phenomena of arcing, ignition, breakdown, damage to high-voltage power supply (arcing and breakdown will impact the high-voltage power supply to cause irreversible damage to the high-voltage power supply), starting a protection mechanism by the high-voltage power supply, no output and the like will occur.

### SUMMARY

In view of the shortcomings in the prior art, an ion box compatible with direct-current power supply and vortex power supply, and a purification device are proposed to solve the problem in the prior art that the purification efficiency is affected by frequent cleaning and maintenance of the purification device.

To achieve the above objective, the present invention provides the following technical solution.

According to a first aspect, the present invention provides an ion box compatible with direct-current power supply and vortex power supply, including a frame, where a dust collection area and an ionization area are arranged inside the frame in parallel, both the dust collection area and the ionization area include a plurality of polar plates parallel to each other and arranged at intervals, a distance between adjacent low-voltage polar plates or adjacent high-voltage polar plates located in the ionization area is 44-58 mm, a distance between adjacent low-voltage polar plates located in the dust collection area is 11-16 mm, each of the high-voltage polar plates is distributed between the low-voltage polar plates, an ionization electric field is formed inside the ionization area, and a voltage of ionization electric field is 12-19 kV.

This technical solution is further set as follows: a first distance is present between the tops of the polar plates of the dust collection area and the frame in a vertical direction, and the first distance is greater than or equal to a distance between the adjacent high-voltage polar plates and low-voltage polar plates of the dust collection area.

This technical solution is further set as follows: corners of the polar plates of the dust collection area are set as avoiding structures for avoiding the frame.

This technical solution is further set as follows: in the dust collection area, an inclined line is formed between an end portion of each of the high-voltage polar plates close to the ionization area and an end portion of each of the low-voltage polar plates close to the ionization area, an included angle between the inclined line and a first direction is 0°-60°, and the first direction is parallel to a direction from an air inlet side of the ionization box to a leeward side of the ionization box.

This technical solution is further set as follows: the ion box compatible with direct-current power supply and vortex power supply further includes a high-voltage power supply, where the high-voltage power supply is at least electrically connected to the ionization area, a dust collection electric field is formed inside the dust collection area, and a voltage of the dust collection electric field is 5-8 kV.

This technical solution is further set as follows: the high-voltage polar plates of the ionization area are electrically connected to a high-voltage end of the high-voltage power supply through a first conductive rod, a first avoiding hole for the first conductive rod to penetrate through is formed in each of the low-voltage polar plates of the ionization area, a second conductive rod is connected between the high-voltage polar plates of the dust collection area, a second avoiding hole for the second conductive rod to penetrate through is formed in each of the low-voltage polar plates of the dust collection area, and a hole diameter of the first avoiding hole is greater than that of the second avoiding hole.

This technical solution is further set as follows: a voltage drop per unit distance between an edge of the first avoiding hole and the first conductive rod is not greater than that between an edge of the second avoiding hole and the second conductive rod.

This technical solution is further set as follows: in the ionization area, a mounting hole for the first conductive rod to penetrate through is formed in each of the high-voltage polar plates, a first ionization sawtooth is arranged on a side surface of each of the high-voltage polar plates close to the air inlet side of the ion box, a second ionization sawtooth is arranged on a side surface of each of the high-voltage polar plates close to the leeward side of the ion box, a distance between the first ionization sawtooth and the mounting hole in the first direction serves as a second distance, a distance between the second ionization sawtooth and the mounting hole in the first direction serves as a third distance, and the second distance is less than the third distance.

This technical solution is further set as follows: the first ionization sawtooth and the second ionization sawtooth have the same structure, both of them are staggered in a height direction of the ion box, and a difference value between the second distance and the third distance is 3/10 to ½ of a distance between adjacent second ionization sawteeth.

This technical solution is further set as follows: wind deflectors are arranged at the tops and bottoms of the low-voltage polar plates of the ionization area, the wind deflectors are arranged obliquely, and a distance between an end portion of each of the wind deflectors close to the air inlet side of the ion box and the frame is less than a distance between an end portion of each of the wind deflectors close to the leeward side of the ion box and the frame.

This technical solution is further set as follows: an included angle between each of the wind deflectors and the first direction is 10°-30°, and the first direction is parallel to a direction from an air inlet side of the ionization box to a leeward side of the ionization box.

This technical solution is further set as follows: the bottoms of the low-voltage polar plates of the ionization area are connected to the frame through a connecting plate, and a height of the connecting plate is not greater than a height of a lower edge strip of the frame.

According to a second aspect, the present invention provides a purification device, including a box body and a high-voltage power supply, where an air inlet and an air outlet are respectively formed in side surfaces of the box body, an electrostatic dust removal unit is arranged inside the box body, the electrostatic dust removal unit adopts the ion box compatible with direct-current power supply and vortex power supply, and the high-voltage power supply is electrically connected to the ion box compatible with direct-current power supply and vortex power supply.

The present invention has the following beneficial effects:
the ion box meets a double power supply mode of high-voltage power supply direct-current power supply and vortex power supply, and has a wider application range;
the space utilization rate is higher and the design is more reasonable; the electrical safety in early and late operation periods can be taken into account by optimizing the distance between the adjacent low-voltage polar plates or the adjacent high-voltage polar plates of the ionization area and the voltage parameter of the ionization electric field; and the purification efficiency is high, the maintenance cycle is long, the user maintenance frequency is reduced, and the maintenance cost is low.

### BRIEF DESCRIPTION OF THE DRAWINGS

FIG. 1 is an axial side view of an ion box compatible with direct-current power supply and vortex power supply according to an embodiment of the present invention;

FIG. 2 is a left view of an ion box compatible with direct-current power supply and vortex power supply according to an embodiment of the present invention;

FIG. 3 is a right view of an ion box compatible with direct-current power supply and vortex power supply according to an embodiment of the present invention; and

FIG. 4 is a top view of an ion box compatible with direct-current power supply and vortex power supply according to an embodiment of the present invention.

### DETAILED DESCRIPTION OF THE EMBODIMENTS

To make those skilled in the art better understand the technical solutions of the present invention, the technical solutions of the present invention are clearly and completely described below with reference to the accompanying drawings of the present invention. Other embodiments obtained by a person of ordinary skill in the art based on the embodiments of the present application without creative efforts shall fall within the protection scope of the present application. In addition, the directional terms mentioned in the following embodiments, such as “up”, “down”, “left”, “right”, etc., are merely referring to the directions in the accompanying drawings. Therefore, the used directional terms are intended to illustrate rather than limit the present invention.

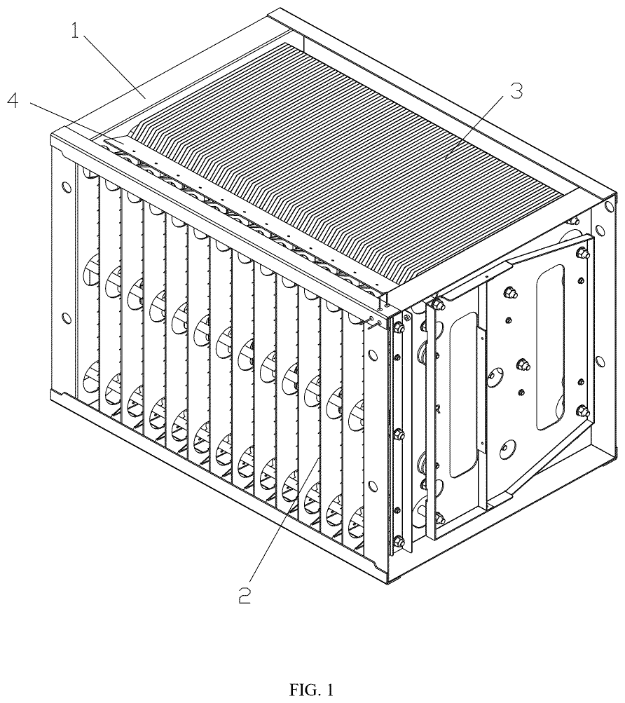

According to embodiments of the present invention, an ion box compatible with direct-current power supply and vortex power supply is provided. Referring to FIG. 1, the ion box includes a frame 1, where a dust collection area 3 and an ionization area 2 are arranged inside the frame 1 in parallel, both the dust collection area 3 and the ionization area 2 include a plurality of polar plates parallel to each other and arranged at intervals, a distance between adjacent low-voltage polar plates or adjacent high-voltage polar plates located in the ionization area 2 is 44-58 mm, a distance between adjacent low-voltage polar plates located in the dust collection area 3 is 11-16 mm, each of the high-voltage polar plates is distributed between the low-voltage polar plates, an ionization electric field is formed inside the ionization area 2, and a voltage of ionization electric field is 12-19 kV.

In the ion box compatible with direct-current power supply and vortex power supply according to this embodiment, referring to FIG. 1, the polar plates of the dust collection area 3 include high-voltage polar plates and low-voltage polar plates; the tops of the high-voltage polar plates and the low-voltage polar plates are flush, and the bottoms are also flush; the frame on two sides plays the role of the low-voltage polar plates; and a first distance is present between the tops of the polar plates (including the high-voltage polar plates and the low-voltage polar plates) of the dust collection area and the frame 1 in a vertical direction, and the first distance is greater than or equal to a distance between the adjacent high-voltage polar plates and low-voltage polar plates of the dust collection area.

It should be noted that when the first distance is greater than or equal to the distance between the adjacent high-voltage polar plates and low-voltage polar plates of the dust collection area, the electrical safety can be ensured; and the frame 1 is a metal frame body, the metal frame body and the high-voltage polar plates require a safe distance, and the safe distance is determined by the distance between the high-voltage polar plates and the low-voltage polar plates. To ensure the purification effect, a high voltage will be designed at a limited distance on the premise of considering safety; and when the first distance is greater than or equal to ½ of the distance between the adjacent high-voltage polar plates and low-voltage polar plates of the dust collection area, the same safe voltage design can be ensured between the high-voltage polar plates and the low-voltage polar plates as well as between the high-voltage polar plates and the frame 1, and the space utilization rate is higher. If the first distance is less than the distance between the adjacent high-voltage polar plates and low-voltage polar plates of the dust collection area, the breakdown and ignition phenomena between the high-voltage polar plates and the frame 1 may occur.

In some other embodiments, the tops and bottoms of the high-voltage polar plates and the low-voltage polar plates are not flush; and at this time, the distance between the tops of the high-voltage polar plates and the frame 1 in the vertical direction is greater than or equal to the distance between the adjacent high-voltage polar plates and low-voltage polar plates of the dust collection area, and the same technical effect also can be achieved.

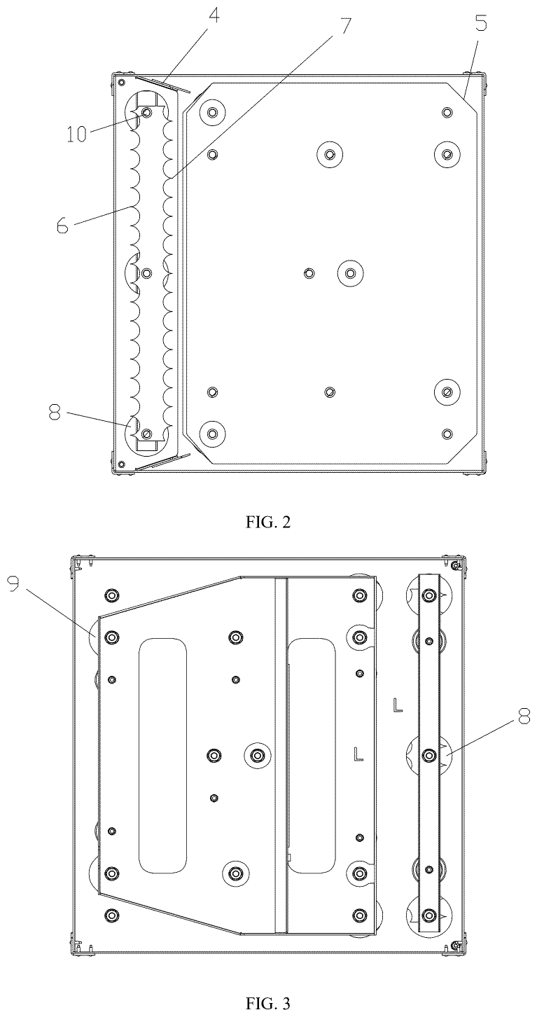

In the ion box compatible with direct-current power supply and vortex power supply according to this embodiment, referring to FIG. 1 and FIG. 2, corners of the polar plates of the dust collection area 3 are set as avoiding structures 5 of the frame 1.

It should be noted that the corners of the polar plates of the dust collection area are set as the avoiding structures 5 of the frame 1, which is conducive to increasing the space utilization rate. The high-voltage polar plates and low-voltage polar plates of the dust collection area are required to maintain a safe distance from the frame 1. If the avoiding structures 5 are not made, the high-voltage polar plates and low-voltage polar plates of the dust collection area reduce the area of the high-voltage polar plates and low-voltage polar plates of the dust collection area to avoid the frame 1, thereby reducing the effective adsorption area per unit volume of the dust collection area, reducing the purification efficiency, reducing the dust holding capacity of the ion box and shortening the maintenance cycle of the ion box.

In the ion box compatible with direct-current power supply and vortex power supply according to this embodiment, referring to FIG. 1, in the dust collection area 3, an inclined line is formed between an end portion of each of the high-voltage polar plates close to the ionization area 2 and an end portion of each of the low-voltage polar plates close to the ionization area 2, an included angle between the inclined line and a first direction is 0°-60°, and the first direction is parallel to a direction from an air inlet side of the ionization box to a leeward side of the ionization box.

That is, in the dust collection area 3, the high-voltage polar plates are closer to the ionization area 2 relative to the low-voltage polar plates, and an ideal induced voltage can be obtained, so that the PM2.5 purification efficiency of the ion box with the same outline size is higher, and the actual operation requirement is met more easily. The induced voltage is low and the PM2.5 purification efficiency is slightly low when the included angle is less than 0°; and when the included angle is greater than 60°, the induced voltage is easy to implement, but the PM2.5 purification efficiency is slightly low. The main reason is that in the ion box with the same outline volume, the effective dust collection area of the dust collection area 3 is significantly reduced, so that the effective adsorption of the particulate matters is affected.

The ion box compatible with direct-current power supply and vortex power supply according to this embodiment, referring to FIG. 1, further includes a high-voltage power supply, where the high-voltage power supply is at least electrically connected to the ionization area 2, a dust collection electric field is formed inside the dust collection area 3, and a voltage of the dust collection electric field is 5-8 kV.

It should be noted that the inventor made a system test experiment on key parameters of the dust collection area of the ion box on the premise of comprehensively considering the PM2.5 purification efficiency, the electrical safety and the production cost, based on the ion with the same outline size and under the condition of controllable environmental operation parameters. The experimental results are shown in Table 1 and Table 2.

TABLE 1

| | Ionization Area | | Dust Collection Area | | | | | | |
|---|---|---|---|---|---|---|---|---|---|
| | Distance | | Distance | | | | | | |
| | between | | between | | | | | Electrical | |
| | adjacent | | adjacent | | Surface | PM2.5 | Electrical | Safety of | |
| | low-voltage | | low-voltage | | Air | Purification | Safety of | Dust | |
| Serial | polar plates | Voltage | polar plates | Voltage | Velocity | Efficiency | Ionization | Collection | Cost of |
| No. | mm | KV | mm | KV | m/s | % | Area | Area | Ion Box |
| 1 | 53 | −16 | 9 | −7 | 5 | High | Safe | Safe | High |
| 2 | 53 | −16 | 10 | −7 | 5 | High | Safe | Safe | High |
| 3 | 53 | −16 | 11 | −7 | 5 | High | Safe | Safe | Medium |
| 4 | 53 | −16 | 12 | −7 | 5 | High | Safe | Safe | Medium |
| 5 | 53 | −16 | 13 | −7 | 5 | High | Safe | Safe | Medium |
| 6 | 53 | −16 | 14 | −7 | 5 | High | Safe | Safe | Medium |
| 7 | 53 | −16 | 15 | −7 | 5 | High | Safe | Safe | Medium |
| 8 | 53 | −16 | 16 | −7 | 5 | Medium | Safe | Safe | Medium |
| 9 | 53 | −16 | 17 | −7 | 5 | Low | Safe | Safe | Low |

It can be seen from Table 1 that when the distance between the adjacent low-voltage polar plates of the dust collection area is less than 11 mm, for the per unit volume of ion box, the dust collection area 3 has a large material use amount and high material cost, is not conducive to cost control, is not conducive to controlling the electrical safety of the dust collection area 3, and is prone ignition and breakdown phenomena in the late operation period. When the distance between the adjacent low-voltage polar plates of the dust collection area is greater than 16 mm, for the per unit volume of ion box, the material use amount is low, but the PM2.5 purification efficiency is low, which is not conducive to ensuring the purification efficiency.

TABLE 2

| | Ionization Area | | Dust Collection Area | | | | | | |
|---|---|---|---|---|---|---|---|---|---|
| | Distance | | Distance | | | | | | |
| | between | | between | | | | | Electrical | |
| | adjacent | | adjacent | | Surface | PM2.5 | Electrical | Safety of | |
| | low-voltage | | low-voltage | | Air | Purification | Safety of | Dust | |
| Serial | polar plates | Voltage | polar plates | Voltage | Velocity | Efficiency | Ionization | Collection | Cost of |
| No. | mm | KV | mm | KV | m/s | % | Area | Area | Ion Box |
| 1 | 53 | −15 | 11 | −4.8 | 5 | 88.2 | Safe | Safe | Medium |
| 2 | 53 | −15 | 11 | −5 | 5 | 92.3 | Safe | Safe | Medium |
| 3 | 53 | −15 | 11 | −6.5 | 5 | 97.5 | Safe | Safe | Medium |
| 4 | 53 | −15 | 11 | −8 | 5 | 99.2 | Safe | Safe | Medium |
| 5 | 53 | −15 | 11 | −8.2 | 5 | 99.3 | Safe | Easy ignition | Medium |
| | | | | | | | | and unsafe | |
| 6 | 53 | −15 | 14 | −4.8 | 5 | 84.3 | Safe | Safe | Slightly |
| | | | | | | | | | low |
| 7 | 53 | −15 | 14 | −5 | 5 | 93.5 | Safe | Safe | Slightly |
| | | | | | | | | | low |
| 8 | 53 | −15 | 14 | −6.5 | 5 | 95.2 | Safe | Safe | Slightly |
| | | | | | | | | | low |
| 9 | 53 | −15 | 14 | −8 | 5 | 97.6 | Safe | Safe | Slightly |
| | | | | | | | | | low |
| 10 | 53 | 15 | 14 | −8.2 | 5 | 98.3 | Safe | Easy ignition | Slightly |
| | | | | | | | | and unsafe | low |
| 11 | 53 | −15 | 16 | −4.8 | 5 | 81.5 | Safe | Safe | Low |
| 12 | 53 | −15 | 16 | −5 | 5 | 91.7 | Safe | Safe | Low |
| 13 | 53 | −15 | 16 | −6.5 | 5 | 93.4 | Safe | Safe | Low |
| 14 | 53 | −15 | 16 | −8 | 5 | 96.2 | Safe | Safe | Low |
| 15 | 53 | −15 | 16 | −8.2 | 5 | 97.5 | Safe | Easy ignition | Low |
| | | | | | | | | and unsafe | |

It can be seen from Table 2 that when the voltage absolute value of the dust collection area is less than 5 KV, the distance between the adjacent low-voltage polar plates of the dust collection area is slightly large, for example, 14 mm and 16 mm, the PM2.5 purification efficiency is less than 90%, and the efficiency is slightly low. When the voltage absolute value of the dust collection area 3 is greater than 8 KV, the distance between the adjacent low-voltage polar plates of the dust collection area is slightly small, for example, 13 mm and 10 mm, which is electrically unsafe. Meanwhile, due to the excessive voltage absolute value, the overall electrical design requirement on the ion box is high, and the cost and the after-sale maintenance cost will also be indirectly increased.

In addition, the inventor made a system test experiment on key parameters of the ionization area of the ion box on the premise of comprehensively considering the PM2.5 purification efficiency, the electrical safety and the production cost, based on the ion with the same outline size and under the condition of controllable environmental operation parameters. The experimental result is shown in Table 3.

TABLE 3

| | Ionization Area | | Dust Collection Area | | | | | | |
|---|---|---|---|---|---|---|---|---|---|
| | Distance | | Distance | | | | | | |
| | between | | between | | | | | Electrical | |
| | adjacent | | adjacent | | Surface | PM2.5 | Electrical | Safety of | |
| | low-voltage | | low-voltage | | Air | Purification | Safety of | Dust | |
| Serial | polar plates | Voltage | polar plates | Voltage | Velocity | Efficiency | Ionization | Collection | Cost of |
| No. | mm | KV | mm | KV | m/s | % | Area | Area | Ion Box |
| 1 | 40 | −11 | 14 | −6 | 5 | 93.5 | Safe | Safe | High |
| 2 | 43 | −11 | 14 | −6 | 5 | 92.4 | Safe | Safe | High |
| 3 | 44 | −11 | 14 | −6 | 5 | 89.6 | Safe | Safe | Medium |
| 4 | 47 | −11 | 14 | −6 | 5 | 88.4 | Safe | Safe | Medium |
| 5 | 50 | −11 | 14 | −6 | 5 | 87.6 | Safe | Safe | Slightly |
| | | | | | | | | | low |
| 6 | 54 | −11 | 14 | −6 | 5 | 86.3 | Safe | Safe | Slightly |
| | | | | | | | | | low |
| 7 | 58 | −11 | 14 | −6 | 5 | 84.5 | Safe | Safe | Low |
| 8 | 59 | −11 | 14 | −6 | 5 | 83.2 | Safe | Safe | Low |
| 9 | 60 | −11 | 14 | −6 | 5 | 81.1 | Safe | Safe | Low |
| 10 | 40 | −12 | 14 | −6 | 5 | 95.6 | Safe | Safe | High |
| 11 | 43 | −12 | 14 | −6 | 5 | 94.5 | Safe | Safe | High |
| 12 | 44 | −12 | 14 | −6 | 5 | 93.2 | Safe | Safe | Medium |
| 13 | 47 | −12 | 14 | −6 | 5 | 92.4 | Safe | Safe | Medium |
| 14 | 50 | −12 | 14 | −6 | 5 | 92.6 | Safe | Safe | Slightly |
| | | | | | | | | | low |
| 15 | 54 | −12 | 14 | −6 | 5 | 91.4 | Safe | Safe | Slightly |
| | | | | | | | | | low |
| 16 | 58 | −12 | 14 | −6 | 5 | 90.6 | Safe | Safe | Low |
| 17 | 59 | −12 | 14 | −6 | 5 | 84.6 | Safe | Safe | Low |
| 18 | 60 | −12 | 14 | −6 | 5 | 82.3 | Safe | Safe | Low |
| 19 | 40 | −15 | 14 | −6 | 5 | 97.5 | Safe | Safe | High |
| 20 | 43 | −15 | 14 | −6 | 5 | 96.6 | Safe | Safe | High |
| 21 | 44 | −15 | 14 | −6 | 5 | 95.4 | Safe | Safe | Medium |
| 22 | 47 | −15 | 14 | −6 | 5 | 94.3 | Safe | Safe | Medium |
| 23 | 50 | −15 | 14 | −6 | 5 | 93.9 | Safe | Safe | Slightly |
| | | | | | | | | | low |
| 24 | 54 | −15 | 14 | −6 | 5 | 92.4 | Safe | Safe | Slightly |
| | | | | | | | | | low |
| 25 | 58 | −15 | 14 | −6 | 5 | 91.3 | Safe | Safe | Low |
| 26 | 59 | −15 | 14 | −6 | 5 | 85.4 | Safe | Safe | Low |
| 27 | 60 | −15 | 14 | −6 | 5 | 83.6 | Safe | Safe | Low |
| 28 | 40 | −19 | 14 | −6 | 5 | 98.3 | Easy | Safe | High |
| | | | | | | | ignition and | | |
| | | | | | | | unsafe | | |
| 29 | 43 | −19 | 14 | −6 | 5 | 97.5 | Easy | Safe | High |
| | | | | | | | ignition and | | |
| | | | | | | | unsafe | | |
| 30 | 44 | −19 | 14 | −6 | 5 | 96.4 | Safe | Safe | Medium |
| 31 | 47 | −19 | 14 | −6 | 5 | 95.2 | Safe | Safe | Medium |
| 32 | 50 | −19 | 14 | −6 | 5 | 94.5 | Safe | Safe | Slightly |
| | | | | | | | | | low |
| 33 | 54 | −19 | 14 | −6 | 5 | 93.4 | Safe | Safe | Slightly |
| | | | | | | | | | low |
| 34 | 58 | −19 | 14 | −6 | 5 | 92.6 | Safe | Safe | Low |
| 35 | 59 | −19 | 14 | −6 | 5 | 86.2 | Safe | Safe | Low |
| 36 | 60 | −19 | 14 | −6 | 5 | 84.5 | Safe | Safe | Low |
| 37 | 40 | −20 | 14 | −6 | 5 | 99.1 | Easy | Safe | High |
| | | | | | | | ignition and | | |
| | | | | | | | unsafe | | |
| 38 | 43 | −20 | 14 | −6 | 5 | 98.6 | Easy | Safe | High |
| | | | | | | | ignition and | | |
| | | | | | | | unsafe | | |
| 39 | 44 | −20 | 14 | −6 | 5 | 97.9 | Easy | Safe | Medium |
| | | | | | | | ignition and | | |
| | | | | | | | unsafe | | |
| 40 | 47 | −20 | 14 | −6 | 5 | 96.6 | Easy | Safe | Medium |
| | | | | | | | ignition and | | |
| | | | | | | | unsafe | | |
| 41 | 50 | −20 | 14 | −6 | 5 | 95.4 | Easy | Safe | Slightly |
| | | | | | | | ignition and | | low |
| | | | | | | | unsafe | | |
| 42 | 54 | −20 | 14 | −6 | 5 | 94.6 | Easy | Safe | Slightly |
| | | | | | | | ignition and | | low |
| | | | | | | | unsafe | | |
| 43 | 58 | −20 | 14 | −6 | 5 | 93.2 | Easy | Safe | Low |
| | | | | | | | ignition and | | |
| | | | | | | | unsafe | | |
| 44 | 59 | −20 | 14 | −6 | 5 | 87.3 | Safe | Safe | Low |
| 45 | 60 | −20 | 14 | −6 | 5 | 85.5 | Safe | Safe | Low |

It can be seen from Table 3 that when the distance between the adjacent low-voltage polar plates of the ionization area is less than 44 mm, for the per unit volume of ion box, high material use amount and high material cost are not conducive to cost control; and when the distance between the adjacent low-voltage polar plates of the ionization area is greater than 58 mm, for the per unit volume of ion box, due to the poor effect of ionizing the air in the ionization area and the insufficient charging of the particulate matters, the PM2.5 purification efficiency is slightly low, and the actual operation requirement cannot be met.

When the absolute value of the voltage parameter of the ionization area 2 is less than 12 KV, the poor effect of ionizing the air in the ionization area 2 is not conducive to the sufficient charging of the particulate matters, so that the PM2.5 purification efficiency is low, and the performance requirement of the actual operation cannot be met. When the absolute value of the voltage parameter of the ionization area 2 is greater than 19 KV, the effect of ionizing the air in the ionization area 2 is good, but it is easy to ignite, which is electrically unsafe and not conducive to electrical safety control, so that the performance requirement of the actual operation cannot be met, and the design cost and the after-sale maintenance cost will also be indirectly increased. Under the conditions of a small distance between the adjacent low-voltage polar plates of the ionization area 2 and a high voltage of the ionization area, such as −19 KV, similarly, the ionization area is easy to ignite, which is electrically unsafe and not conducive to electrical safety control, so that the performance requirement of the actual operation cannot be met.

Specifically, the high-voltage power supply is only electrically connected to the ionization area 2. Since the high-voltage polar plates of the dust collection area 3 are closer to the ionization area 2 relative to the low-voltage polar plates, so a relatively high induced voltage is formed inside the dust collection area 3, and the vortex power supply mode is achieved. The vortex power supply mode has the advantages that the number of high-voltage contacts is reduced, the safety is higher, immediate washing and use can be achieved, the material use amount of the ion box is less, and the cost is lower.

Specifically, the high-voltage power supply is electrically connected to the polar plates of the dust collection area 3 and the ionization area 2, respectively, so that the direct-current power supply mode is achieved. The direct-current power supply mode can cope with environmental purification with higher air volume and more serious pollution.

In the ion box compatible with direct-current power supply and vortex power supply according to this embodiment, referring to FIG. 1 to FIG. 3, the high-voltage polar plates of the ionization area 2 are electrically connected to a high-voltage end of the high-voltage power supply through a first conductive rod, a first avoiding hole 8 for the first conductive rod to penetrate through is formed in each of the low-voltage polar plates of the ionization area 2, a second conductive rod is connected between the high-voltage polar plates of the dust collection area 3, a second avoiding hole for the second conductive rod 9 to penetrate through is formed in each of the low-voltage polar plates of the dust collection area 3, and a hole diameter of the first avoiding hole 8 is greater than that of the second avoiding hole 9.

In the ion box compatible with direct-current power supply and vortex power supply according to this embodiment, referring to FIG. 1 to FIG. 3, a voltage drop per unit distance between an edge of the first avoiding hole 8 and the first conductive rod is not greater than that between an edge of the second avoiding hole 9 and the second conductive rod.

It should be noted that the voltage drop per unit distance refers to a ratio of the voltage value to the distance. To improve the effect of ionizing the air, it is necessary to adopt a higher voltage absolute value to generate a large number of ions, so that the particulate matters in the air can be effectively charged; meanwhile, the higher voltage absolute value will cause the air to generate air discharge, and a higher safe distance is required; and in the ionization area, it is necessary to improve the effect of ionizing the air as much as possible on the premise of taking the electrical safety into account, while in the dust collection area, an electric field formed by the high-voltage and low-voltage polar plates mainly completes the adsorption action of the particulate matters in the air. In the design, the voltage value of the ionization area is increased as much as possible, the voltage value of the dust collection area is controlled, the distance between the low-voltage polar plates of the ionization area is larger, the number of the high-voltage and low-voltage polar plates of the dust collection area is larger, under the same voltage drop, the more the number, the more likely it is to fail; and with the increase of the dust collection amount of the dust collection area, the difficulty of electrical safety control will be further increased. On the premise of ensuring the electrical safety, the design of the structure fully exerts the action effects of different function sections of the ionization area and the dust collection area, and takes into account the electrical safety of the dust collection area in the early and late operation periods.

In the ion box compatible with direct-current power supply and vortex power supply according to this embodiment, referring to FIG. 1 to FIG. 3, in the ionization area 2, a mounting hole 10 for the first conductive rod to penetrate through is formed in each of the high-voltage polar plates, a first ionization sawtooth 6 is arranged on a side surface of each of the high-voltage polar plates close to the air inlet side of the ion box, a second ionization sawtooth 7 is arranged on a side surface of each of the high-voltage polar plates close to the leeward side of the ion box, a distance between the first ionization sawtooth 6 and the mounting hole 10 in the first direction serves as a second distance, a distance between the second ionization sawtooth 7 and the mounting hole 10 in the first direction serves as a third distance, and the second distance is less than the third distance, that is, the mounting hole 10 is arranged close to the first ionization sawtooth 6.

In the ion box compatible with direct-current power supply and vortex power supply according to this embodiment, referring to FIG. 1 to FIG. 3, the first ionization sawtooth 6 and the second ionization sawtooth 7 have the same structure and are arranged in a height direction of the ion box in a staggered manner to solve an ionization blind area, the first ionization sawtooth 6 and the second ionization sawtooth 7 form effective charges of particulate matters and other pollutants passing through the air through scattering, and a difference value between the second distance and the third distance is 3/10 to ½ of a distance between the adjacent second ionization sawteeth. The closer the high-voltage polar plates of the ionization area is to the dust collection area, the higher the induced voltage is and the higher the PM2.5 purification efficiency of the ion box is, but when the distance is short to a certain extent, the electrical safety is not easy to control.

Based on the same dust collection area, the inventor designed different ionization areas to perform efficiency test experiments, and found that when the difference value between the second distance and the third distance is 3/10 to ½ of the distance between the adjacent second ionization sawteeth, the PM2.5 purification efficiency can be greater than 90%, the requirement of the actual operation is met, and the experimental results are shown in Table 4.

TABLE 4

| | Ionization Area | | | PM2.5 | |
|---|---|---|---|---|---|
| | Difference | | Surface Air | Purification | |
| Serial | ratio | Voltage | Velocity | Efficiency | Electrical |
| No. | / | KV | m/s | % | Safety |
| 1 | 0.25 | −17 | 4.5 | 98.5 | Easy to cause |
| | | | | | ignition |
| 2 | 0.3 | −17 | 4.5 | 96.6 | Safe |
| 3 | 0.4 | −17 | 4.5 | 94.9 | Safe |
| 4 | 0.5 | −17 | 4.5 | 92.5 | Safe |
| 5 | 0.55 | −17 | 4.5 | 86.7 | Safe |

It can be seen from Table 4 that the high-voltage polar plates of the ionization area are close to the dust collection area, so that the induced voltage can be increased, the purification efficiency can be improved, and the maintenance cycle can be prolonged.

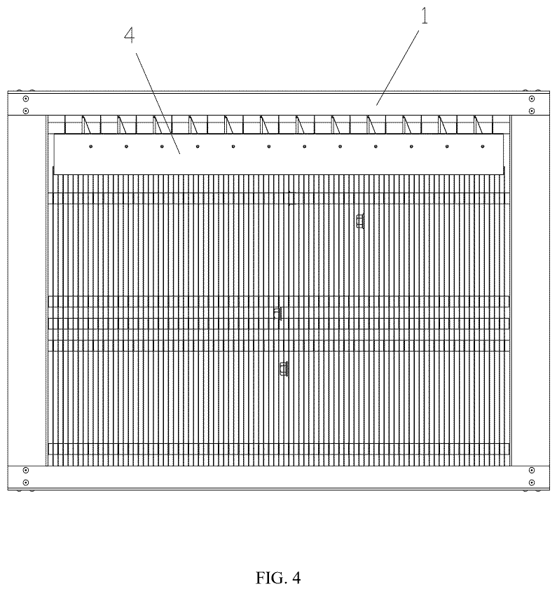

In the ion box compatible with direct-current power supply and vortex power supply according to this embodiment, referring to FIG. 1 to FIG. 4, wind deflectors 4 are arranged at the tops and bottoms of the low-voltage polar plates of the ionization area, the wind deflectors 4 are arranged obliquely, and a distance between an end portion of each of the wind deflectors 4 close to the air inlet side of the ion box and the frame is less than a distance between an end portion of each of the wind deflectors close to the leeward side of the ion box and the frame.

It should be noted that the wind deflectors 4 guide the air to enter the dust collection area 3, thereby preventing the air from escaping from above the dust collection area 3.

Preferably, an included angle between each of the wind deflectors 4 and the first direction is 10°-30°, and the first direction is parallel to a direction from an air inlet side of the ionization box to a leeward side of the ionization box. The wind deflectors 4 mainly play a role in guiding airflow. When the included angle is less than 10°, the wind guide effect is not ideal, which is manifested in the reduction of the purification efficiency, because some air directly enters the uncontrollable space between the tops and bottoms of the polar plates and the frame 1, resulting in that the particulate matters cannot be effectively adsorbed. When the included angle is greater than 30°, the airflow deviates too much from the original track, the resistance is increased and the purification efficiency is reduced, because the airflow has a larger guide angle, resulting in high air flow velocity in the local purification area, non-uniform airflow and reduced purification efficiency; meanwhile, due to the reduced the local ventilation area, the resistance is significantly increased. Through comprehensive comparison, 10° to 30° is a better design parameter.

In the ion box compatible with direct-current power supply and vortex power supply according to this embodiment, referring to FIG. 1, the bottoms of the low-voltage polar plates of the ionization area 2 are connected to the frame 1 through a connecting plate, and a height of the connecting plate is not greater than a height of a lower edge strip of the frame 1.

It should be noted that the connecting plate is conducive to fixing the low-voltage polar plats of the ionization area 2, and the height of the connecting plate is not greater than the height of the lower edge strip of the frame 1, so that the effects of no windproofness, low resistance and high space utilization rate are achieved.

According to the embodiments of the present invention, a purification device is provided and includes a box body and a high-voltage power supply, where an air inlet and an air outlet are respectively formed in side surfaces of the box body, an electrostatic dust removal unit is arranged inside the box body, the electrostatic dust removal unit adopts the ion box compatible with direct-current power supply and vortex power supply, and the high-voltage power supply is electrically connected to the ion box compatible with direct-current power supply and vortex power supply.

The present invention has been described in detail above, and the above mentioned is only a preferred embodiment of the present invention and is not intended to limit the implementation scope of the present invention, i.e. all equivalent variations and modifications made within the claims of the present invention shall be included within the scope of the present invention.

What is claimed is:

1. An ion box compatible with direct-current power supply and vortex power supply, characterized in that, comprising a frame, wherein a dust collection area and an ionization area are arranged inside the frame in parallel, both the dust collection area and the ionization area include a plurality of polar plates parallel to each other and arranged at intervals, a distance between adjacent low-voltage polar plates or adjacent high-voltage polar plates located in the ionization area is 44-58 mm, a distance between adjacent low-voltage polar plates located in the dust collection area is 11-16 mm, each of the high-voltage polar plates is distributed between the low-voltage polar plates, an ionization electric field is formed inside the ionization area, and a voltage of ionization electric field is 12-19 kV.

2. The ion box compatible with direct-current power supply and vortex power supply according to claim 1, characterized in that, a first distance is present between the tops of the polar plates of the dust collection area and the frame in a vertical direction, and the first distance is greater than or equal to a distance between the adjacent high-voltage polar plates and low-voltage polar plates of the dust collection area.

3. The ion box compatible with direct-current power supply and vortex power supply according to claim 2, characterized in that, corners of the polar plates of the dust collection area are set as avoiding structures for avoiding the frame.

4. The ion box compatible with direct-current power supply and vortex power supply according to claim 1, characterized in that, further comprising a high-voltage power supply, wherein the high-voltage power supply is at least electrically connected to the ionization area, a dust collection electric field is formed inside the dust collection area, and a voltage of the dust collection electric field is 5-8 kV.

5. The ion box compatible with direct-current power supply and vortex power supply according to claim 4, characterized in that, in the dust collection area, an inclined line is formed between an end portion of each of the high-voltage polar plates close to the ionization area and an end portion of each of the low-voltage polar plates close to the ionization area, an included angle between the inclined line and a first direction is 0°-60°, and the first direction is parallel to a direction from an air inlet side of the ionization box to a leeward side of the ionization box.

6. The ion box compatible with direct-current power supply and vortex power supply according to claim 1, characterized in that, the high-voltage polar plates of the ionization area are electrically connected to a high-voltage end of the high-voltage power supply through a first conductive rod, a first avoiding hole for the first conductive rod to penetrate through is formed in each of the low-voltage polar plates of the ionization area, a second conductive rod is connected between the high-voltage polar plates of the dust collection area, a second avoiding hole for the second conductive rod to penetrate through is formed in each of the low-voltage polar plates of the dust collection area, and a hole diameter of the first avoiding hole is greater than that of the second avoiding hole.

7. The ion box compatible with direct-current power supply and vortex power supply according to claim 6, characterized in that, a voltage drop per unit distance between an edge of the first avoiding hole and the first conductive rod is not greater than that between an edge of the second avoiding hole and the second conductive rod.

8. The ion box compatible with direct-current power supply and vortex power supply according to claim 6, characterized in that, in the ionization area, a mounting hole for the first conductive rod to penetrate through is formed in each of the high-voltage polar plates, a first ionization sawtooth is arranged on a side surface of each of the high-voltage polar plates close to the air inlet side of the ion box, a second ionization sawtooth is arranged on a side surface of each of the high-voltage polar plates close to the leeward side of the ion box, a distance between the first ionization sawtooth and the mounting hole in the first direction serves as a second distance, a distance between the second ionization sawtooth and the mounting hole in the first direction serves as a third distance, and the second distance is less than the third distance.

9. The ion box compatible with direct-current power supply and vortex power supply according to claim 8, characterized in that, the first ionization sawtooth and the second ionization sawtooth have the same structure, both of them are staggered in a height direction of the ion box, and a difference value between the second distance and the third distance is 3/10 to ½ of a distance between adjacent second ionization sawteeth.

10. The ion box compatible with direct-current power supply and vortex power supply according to claim 1, characterized in that, wind deflectors are arranged at the tops and bottoms of the low-voltage polar plates of the ionization area, the wind deflectors are arranged obliquely, and a distance between an end portion of each of the wind deflectors close to the air inlet side of the ion box and the frame is less than a distance between an end portion of each of the wind deflectors close to the leeward side of the ion box and the frame.

11. The ion box compatible with direct-current power supply and vortex power supply according to claim 10, characterized in that, an included angle between each of the wind deflectors and the first direction is 10°-30°, and the first direction is parallel to a direction from an air inlet side of the ionization box to a leeward side of the ionization box.

12. The ion box compatible with direct-current power supply and vortex power supply according to claim 1, characterized in that, the bottoms of the low-voltage polar plates of the ionization area are connected to the frame through a connecting plate, and a height of the connecting plate is not greater than a height of a lower edge strip of the frame.

13. A purification device, comprising a box body and a high-voltage power supply, wherein an air inlet and an air outlet are respectively formed in side surfaces of the box body, characterized in that, an electrostatic dust removal unit is arranged inside the box body, the electrostatic dust removal unit adopts the ion box compatible with direct-current power supply and vortex power supply according to claim 1, and the high-voltage power supply is electrically connected to the ion box compatible with direct-current power supply and vortex power supply.
